(19) United States
(12) Patent Application Publication
(10) Pub. No.: US 2026/0058479 A1
(43) Pub. Date: Feb. 26, 2026

(54) BLACK START CONTROL METHOD AND SYSTEM FOR DISTRIBUTED ENERGY STORAGE SYSTEM AND PERMANENT-MAGNET DIRECT-DRIVE TYPE WIND TURBINE GENERATOR SET

(71) Applicant: Huaneng Yangjiang Wind Power Generation Co., Ltd., Yangjiang (CN)

(72) Inventors: Xin ZHANG, Yangjiang (CN); Yurong QIU, Yangjiang (CN); Jiewei HUANG, Yangjiang (CN); Yonggang CHEN, Yangjiang (CN); Yaobao LIANG, Yangjiang (CN)

(73) Assignee: Huaneng Yangjiang Wind Power Generation Co., Ltd., Yangjiang (CN)

(21) Appl. No.: 19/306,234

(22) Filed: Aug. 21, 2025

(30) Foreign Application Priority Data
Aug. 22, 2024 (CN) 2024111606593

(51) Int. Cl. H02J 3/46; H02J 3/24; H02J 3/38

(52) U.S. Cl. CPC H02J 3/46; H02J 3/241; H02J 3/381; H02J 2203/20; H02J 2300/28

(57) ABSTRACT

Disclosed are a black start control method and system for a distributed energy storage system and a permanent-magnet direct-drive type wind turbine generator set, which belong to the technical field of power system control. The method is suitable for a black start coordinated control method for distributed energy storage and a wind turbine generator set. The method includes: firstly, controlling a pitch angle based on a direct-current voltage, and flexibly adjusting output of the wind turbine generator set according to load demand; and introducing secondary control into a voltage and current correction process of primary control, so as to realize coordinated control over the distributed energy storage system and the wind turbine generator set.

### CROSS-REFERENCE TO RELATED APPLICATIONS

The application claims priority to Chinese patent application No. 2024111606593, filed on Aug. 22, 2024, the entire contents of which are incorporated herein by reference.

### TECHNICAL FIELD

The present disclosure belongs to the technical field of power system control, and particularly relates to a black start control method and system for a distributed energy storage system and a permanent-magnet direct-drive type wind turbine generator set.

### BACKGROUND

The proportion of renewable energy power generation with high uncertainty and weak controllability, such as wind power generation and photovoltaic power generation, is getting increasingly higher. Moreover, for the majority of wind power generation and photovoltaic power generation, a power grid is connected through power electronic equipment. With electronized power on a grid side and a load side, the risk of system blackout is increased because the system inertia is in a downtrend. It is crucial that black start and power supply recovery are implemented as soon as possible after a blackout accident to enhance power grid toughness, reduce economic losses caused by the accident, and decrease negative social impact. In a traditional black start solution, a hydropower set or a gas set generally functions as a black start power supply, and provides start power for non-black start power supplies such as thermal power plants through power transmission networks, so as to gradually recover power supply to a system. With a continuous increase in the proportion of the renewable energy power generation and aging and decommissioning of thermal power sets, a traditional black start method possibly generates a higher recovery cost and lower efficiency.

With substantial development of energy storage technoloqies and devices, the research and practice have been globally conducted on control methods for system recovery through energy storage and wind power generation, but primarily focus on participation of a single energy storage power station and a wind farm in system recovery. The stored energy serves as a main support power supply of the system, and a wind turbine generator set often employs the grid-following type, i.e. a maximum power tracking control mode. There will be a large quantity of distributed energy storage systems at a power distribution network and a user side in the future. However, owing to a small capacity of the distributed energy storage system, it is necessary to research a black start coordinated control method using multiple distributed energy storage systems and the wind turbine generator set.

### SUMMARY

An objective of the present disclosure is to overcome shortcomings in the prior art, and provide a black start control method and system for a distributed energy storage system and a permanent-magnet direct-drive type wind turbine generator set. Thus, the lack of a black start coordinated control method for multiple distributed energy storage systems and a wind turbine generator set in the prior art is solved.

In order to realize the above objective, the present disclosure employs the technical solution as follows:

A black start control method for a distributed energy storage system and a permanent-magnet direct-drive type wind turbine generator set includes:
S1, reducing power of the wind turbine generator set by adjusting a pitch angle, and outputting, by an inverter, a voltage and a current after power reduction;
S2, transforming an actually-sampled value of the voltage and an actually-sampled value of the current into a voltage in d-axis and q-axis forms and a current in d-axis and q-axis forms respectively;
S3, acquiring, by a power controller, active power and reactive power of the distributed energy storage system or the wind turbine generator set based on the voltage transformed into the d-axis and q-axis forms and the current transformed into the d-axis and q-axis forms;
S4, acquiring, by a droop controller, a d-axis component and a q-axis component of a voltage reference value and a frequency based on the active power and the reactive power of the distributed energy storage system or the wind turbine generator set, where the d-axis component and the q-axis component of the voltage reference value and the frequency are corrected through a reference value output by secondary control, so as to obtain a corrected d-axis component, a corrected q-axis component, and a corrected frequency, and the reference value is acquired by the secondary control through a distribution consistency method;
S5, acquiring, by a voltage outer loop controller, a d-axis component and a q-axis component of a current reference value based on the corrected d-axis component, the corrected q-axis component, and the corrected frequency, and outputting a d-axis component and a q-axis component of the current in combination with the voltage transformed into the d-axis and q-axis forms and the current transformed into the d-axis and q-axis forms that are acquired in S2;
S6, acquiring, by a current inner loop controller, a d-axis component and a q-axis component of the voltage based on the d-axis component and the q-axis component of the current in combination with the voltage and the current that are transformed in form and acquired in S2; and
S7, controlling, by the inverter, the corresponding distributed energy storage system or wind turbine generator set based on the d-axis component and the q-axis component of the voltage.

The present disclosure is further improved as follows:
Preferably, in S1, a process of adjusting the pitch angle includes: generating a direct-current voltage given value after a difference between a rotation speed of a wind turbine or a direct-drive motor and a rotation speed given signal is regulated by a proportional-integral (PI) regulator, calculating a difference between the direct-current voltage given value and a direct-current voltage actual value, and regulating the difference through the PI regulator, and obtaining the pitch angle.

Preferably, in S2, the voltage and the current are transformed into the d-axis and q-axis forms through Park transformation separately.

Preferably, in S3, the power controller is as follows:

$$\{ \begin{matrix}{P}_{i} = \frac{{w}_{c}}{s + {w}_{c}} ( {u}_{odi} {i}_{odi} + {u}_{o q i} {i}_{o q i} ) \\ {Q}_{i} = \frac{{w}_{c}}{s + {w}_{c}} ( {u}_{o q i} {i}_{odi} - {u}_{odi} {i}_{o q i} )\end{matrix} \qquad ( 1 )$$

in the formula, w_{c} denotes a cutoff frequency, s denotes a Laplace variable, u_{odi} and u_{oqi} denote a d-axis component and a q-axis component of a load-side voltage of an i-th distributed unit respectively, i_{odi} and i_{oqi} denote a d-axis component and a q-axis component of a load-side current of the i-th distributed unit respectively, and Pᵢ and Qᵢ denote active power and reactive power of the i-th distributed unit respectively.

Preferably, in S4, the droop controller is as follows:

$$\{ \begin{matrix}{u}_{odi}^{*} = {u}_{n i} - {n}_{i} {P}_{i} \\ {u}_{o q i}^{*} = 0 \\ {f}_{i}^{*} = {f}_{n i} - {m}_{i} {Q}_{i}\end{matrix} \qquad ( 2 )$$

in the formula,

$${u}_{odi}^{*}$$

denotes a d-axis component of a voltage reference value, output in a droop control stage, of an i-th distributed unit, u_{oqi}* denotes a q-axis component of the voltage reference value, output in the droop control stage, of the i-th distributed unit,

$${f}_{i}^{*}$$

denotes a frequency of the i-th distributed unit, uₙᵢ and fₙᵢ denote a rated value of a voltage and a rated value of a frequency of the i-th distributed unit respectively, mᵢ and nᵢ denote a droop coefficient of active power and a droop coefficient of reactive power of the i-th distributed unit respectively, Pᵢ and Qᵢ denote the active power and the reactive power of the i-th distributed unit respectively.

Preferably, in S4, a specific formula for correcting the d-axis component and the q-axis component of the voltage reference value and the frequency through an amount output by the secondary control is as follows:

$${f}_{i}^{c} = {f}_{n i} - {m}_{i} {Q}_{i} + \frac{{\dot{ω}}_{i}^{*}}{2 π} = {f}_{i}^{*} + \frac{{\dot{ω}}_{i}^{*}}{2 π} \qquad ( 8 )$$

$${u}_{odi}^{c} = {u}_{n i} - {n}_{i} {P}_{i} + {\dot{u}}_{odi}^{*} = {u}_{odi}^{*} + {\dot{u}}_{odi}^{*} \qquad ( 9 )$$

in the formula,

$${f}_{i}^{c}$$

denotes a frequency value of the i-th distributed unit after correction through the secondary control,

$${u}_{odi}^{c}$$

denotes a voltage value of the i-th distributed unit after correction through the secondary control,

$${\dot{ω}}_{i}^{*}$$

denotes a change rate of a reference frequency of the i-th distributed unit, and

$${\dot{u}}_{odi}^{*}$$

denotes a charge rate of a reference voltage of the i-th distributed unit.

Preferably, in S4, the distribution consistency method includes: exchanging consistency variable information of each distributed energy storage system or the wind turbine generator set; and causing a consistency variable of each distributed energy storage system or the wind turbine generator set to tend to be consistent through a consistency operation; where the consistency variable includes the frequency, the voltage, the active power, and the reactive power; and a specific process of the consistency operation is as follows:

$${\dot{x}}_{i} = {\sum }_{j ∈ {n}_{i}} {a}_{ij} ( {x}_{j} ( t ) - {x}_{i} ( t ) ) + {g}_{i} ( {x}_{ref} ( t ) - {x}_{i} ( t ) ) \qquad ( 5 )$$

in the formula, \dot{x}ᵢ denotes a change rate of a consistency variable of an i-th distributed unit, aᵢⱼ denotes a weight coefficient of the information from j to i, gᵢ denotes a weight coefficient between the i-th distributed unit and a leader node, nᵢ denotes a set of all distributed units adjacent to the i-th distributed unit, x_{ref}(t) denotes a state parameter of the leader node, xᵢ(t) denotes the i-th distributed unit, and xⱼ(t) denotes a j-th distributed unit.

Preferably, in S5, the voltage outer loop controller is expressed as follows:

$$\{ \begin{matrix}{i}_{di}^{*} = {K}_{pu} ( {u}_{odi}^{*} - {u}_{odi} ) + {K}_{iu} \int ( {u}_{odi}^{*} - {u}_{odi} ) - ω {Cu}_{oqi} + {i}_{odi} \\ {i}_{qi}^{*} = {K}_{pu} ( {u}_{oqi}^{*} - {u}_{oqi} ) + {K}_{iu} \int ( {u}_{oqi}^{*} - {u}_{oqi} ) - ω {Cu}_{odi} + {i}_{oqi}\end{matrix} \qquad ( 3 )$$

in the formula,

$${i}_{di}^{*} and {i}_{qi}^{*}$$

denote the d-axis component and the q-axis component of the current reference value output by the voltage outer loop controller respectively, Kₚᵤ denotes a proportional gain item of a PI controller in a voltage outer loop, Kᵢᵤ denotes an integral gain item of the PI controller, C denotes a filter capacitance value, and w denotes a rated angular frequency.

Preferably, in S6, the current inner loop controller is expressed as follows:

$$\{ \begin{matrix}{u}_{di}^{*} = {K}_{pi} ( {i}_{di}^{*} - {i}_{di} ) + {K}_{ii} \int ( {i}_{di}^{*} - {i}_{di} ) - ω {Li}_{qi} + {u}_{odi} \\ {u}_{qi}^{*} = {K}_{pi} ( {i}_{qi}^{*} - {i}_{qi} ) + {K}_{ii} \int ( {i}_{qi}^{*} - {i}_{qi} ) - ω {Li}_{di} + {u}_{oqi}\end{matrix} \qquad ( 4 )$$

in the formula, u_{di}* and u_{qi}* denote the d-axis component and the q-axis component of the voltage reference value output by the current inner loop controller respectively, i_{di} and i_{qi} denote a d-axis component and a q-axis component of a current flowing through an inductor L respectively, Kₚᵢ denotes a proportional gain item of a PI controller in a current inner loop, Kᵢᵢ denotes an integral gain item of the PI controller, and L denotes a filter inductance value.

A black start control system for a distributed energy storage system and a permanent-magnet direct-drive type wind turbine generator set includes:
a power reduction module configured to reduce power of the wind turbine generator set by adjusting a pitch angle, and output, by an inverter, a voltage and a current after power reduction;
a transformation module configured to transform an actually-sampled value of the voltage and an actually-sampled value of the current into a voltage in d-axis and q-axis forms and a current in d-axis and q-axis forms respectively;
a power control module configured to acquire, by a power controller, active power and reactive power of the distributed energy storage system or the wind turbine generator set based on the voltage transformed into the d-axis and q-axis forms and the current transformed into the d-axis and q-axis forms;
a droop control module configured to acquire, by a droop controller, a d-axis component and a q-axis component of a voltage reference value and a frequency based on the active power and the reactive power of the distributed energy storage system or the wind turbine generator set, where the d-axis component and the q-axis component of the voltage reference value and the frequency are corrected through a reference value output by secondary control, so as to obtain a corrected d-axis component, a corrected q-axis component, and a corrected frequency, and the reference value is acquired by the secondary control through a distribution consistency method;
a voltage control module configured to acquire, by a voltage outer loop controller, a d-axis component and a q-axis component of a current reference value based on the corrected d-axis component, the corrected q-axis component, and the corrected frequency, and output a d-axis component and a q-axis component of the current in combination with the voltage transformed into the d-axis and q-axis forms and the current transformed into the d-axis and q-axis forms that are acquired through the transformation module;
a current control module configured to acquire, by a current inner loop controller, a d-axis component and a q-axis component of the voltage based on the d-axis component and the q-axis component of the current in combination with the voltage and the current that are transformed in form and acquired in S2; and
an inverter module configured to control, by the inverter, the corresponding distributed energy storage system or wind turbine generator set based on the d-axis component and the q-axis component of the voltage.

Compared with the prior art, the present disclosure has the beneficial effects as follows:

According to the present disclosure, the black start control method for a distributed energy storage system and a permanent-magnet direct-drive type wind turbine generator set is disclosed, and a black start coordinated control method for a distributed energy storage system and a wind turbine generator set is provided. Through standby control over the pitch angle based on a direct-current voltage, the output of the wind turbine generator set is flexibly adjusted according to load demand. Moreover, through the primary control and the secondary control, coordinated control over the distributed energy storage system and the wind turbine generator set is achieved. In a black start process, distributed resources of the system are fully utilized to accelerate system recovery, and an active support action of the wind turbine generator set is exerted. Thus, the requirement for an energy storage capacity in a recovery process is lowered. An active support capability of multiple distributed energy storage systems and the wind turbine generator set is fully exerted. Output of each distributed energy storage system, the output of the wind turbine generator set, and a voltage and a frequency of the system are coordinated through a distributed control method. Thus, black start service can be provided for an external power grid.

### BRIEF DESCRIPTION OF DRAWINGS

FIG. 1 is a basic structural diagram of energy storage and a permanent-magnet direct-drive type wind turbine generator set;

FIG. 2 is a diagram of a grid-connected circuit of energy storage and a permanent-magnet direct-drive type wind turbine generator set;

FIG. 3 is a structural diagram of basic control of a grid-side inverter of distributed energy storage system and a wind turbine generator set for black start;

FIG. 4 is a schematic diagram of a communication topology of a distributed energy storage system and a wind turbine generator set;

FIG. 5 is a diagram of dual-loop control of a pitch angle;

FIG. 6 shows a system frequency change when a load is applied in a black start process;

(a) of FIG. 6 shows a system frequency change in a case of primary control only, and (b) of FIG. 6 shows a system frequency change in a case that secondary control is added.

FIG. 7 shows a simulated waveform (without a voltage inner loop) of pitch angle control;

(a) of FIG. 7 shows a rotation speed of a generator, and (b) of FIG. 7 shows a direct-current voltage;

FIG. 8 shows a simulated waveform (with a voltage inner loop) of pitch angle control; and

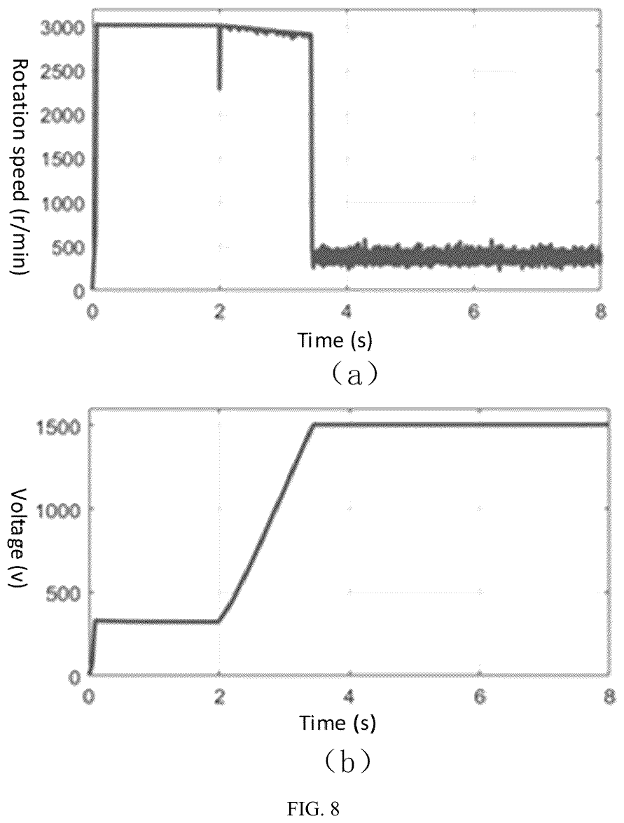

(a) of FIG. 8 shows a rotation speed of a generator, and (b) of FIG. 8 shows a direct-current voltage.

### DETAILED DESCRIPTION OF THE EMBODIMENTS

The present disclosure will be further described in detail below with reference to the accompanying drawings.

In the description of the present disclosure, it should be noted that the orientation or position relations indicated by the terms “center”, “upper”, “lower”, “left”, “right”, “vertical”, “horizontal”, “inner”, “outer”, etc. are based on the orientation or position relations shown in the accompanying drawings, are merely for facilitating the description of the present disclosure and simplifying the description, rather than indicating or implying that the device or element referred to must have a particular orientation or be constructed and operated in a particular orientation, and thus cannot be interpreted as limiting the present disclosure. The terms “first”, “second”, and “third” are merely used for description, and cannot be interpreted as indicating or implying the relative importance. In addition, unless expressly specified and limited otherwise, the terms “mount”, “connect”, and “connection” should be understood broadly, and can denote fixed connection, detachable connection, direct connection, indirect connection through an intermediate medium, or internal communication between two elements. For those of ordinary skill in the art, the specific meanings of the above terms in the present disclosure can be understood according to specific circumstances.

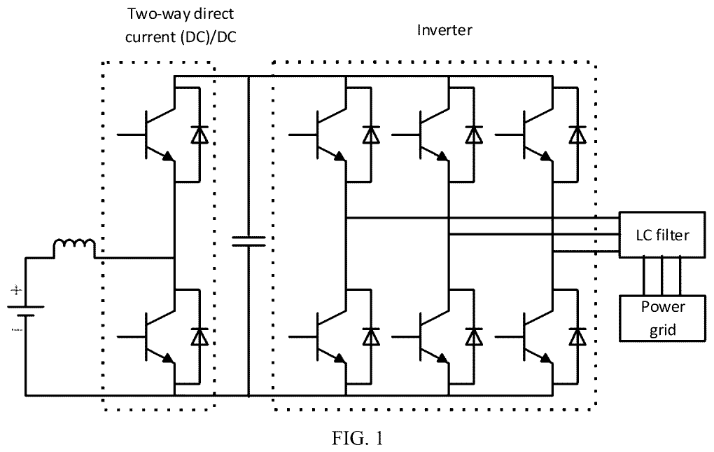

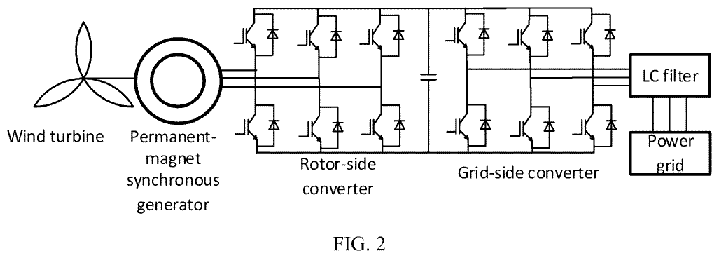

FIG. 1 and FIG. 2 show a basic structural diagram and a diagram of a grid-connected circuit of energy storage and a permanent-magnet direct-drive type wind turbine generator set respectively. Through current actual control, constant direct-current voltage control at an energy storage direct current (DC)/DC circuit and at a wind turbine generator set rotor side is likely to be implemented. Thus, the present disclosure mainly provides a coordinated control method for an energy storage inverter side and a wind turbine generator set grid side, and a control method for a pitch angle of a wind turbine generator set in a black start process. A distributed unit indicates a distributed power generation unit that may be a distributed energy storage system or a wind turbine generator set.

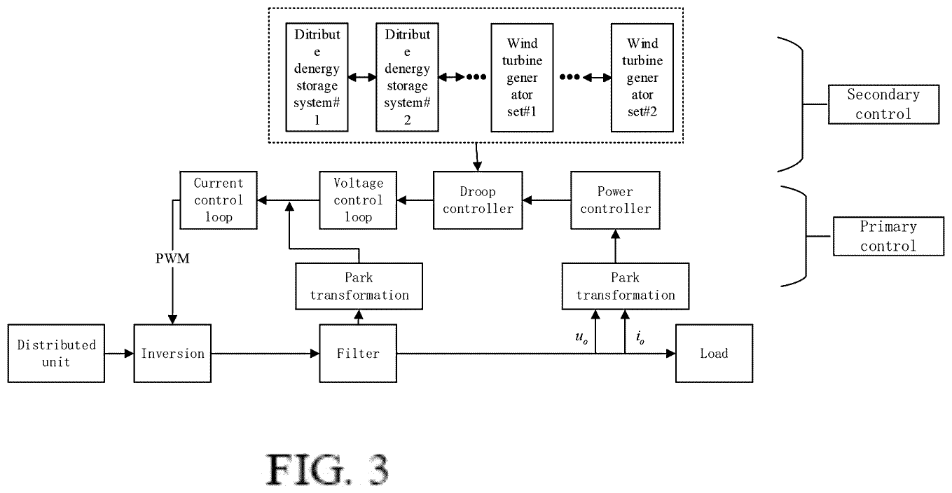

FIG. 3 shows a basic control structure a grid-side inverter of a distributed energy storage system and a wind turbine generator set for black start. The control method includes primary control and secondary control, which are embodied as an upper-layer control unit and a lower-layer control unit respectively. The lower-layer control unit is to control an inverter of a single distributed unit, and is referred to as the primary control. The upper layer is to achieve coordination between the distributed units, and is referred to as the secondary control. The upper-layer secondary control is to calculate corresponding adjustment amounts through given reference values of a voltage and an angular frequency, and feed back the adjustment amounts to the primary control. Thus, coordinated control between the distributed units is achieved.

In a specific process of the method, a standby control method for a pitch angle and the secondary control are introduced into a primary control process. Finally, a voltage and a current of a single distributed energy storage system or the wind turbine generator set are adjusted. A specific process is as follows:
in the primary control process, the wind turbine generator set operates in a power reduction state through the standby control method for a pitch angle. A voltage and a current generated after power reduction are output through an inverter. In a filtering stage, voltages and currents of the distributed energy storage system and the wind turbine generator set are filtered. In a Park transformation stage, a three-phase voltage and a three-phase current are transformed into d-axis and q-axis forms separately. A power controller calculates and outputs active power and reactive power through the d-axis and q-axis forms after transformation. A droop controller calculates a d-axis component and a q-axis component of a voltage and a frequency, output in a droop control stage, of the distributed unit based on the active power and the reactive power in combination with given reference values of a voltage and an angular frequency output by the secondary control. Further, a d-axis component and a q-axis component of a current reference value output by a voltage outer loop controller, and the three-phase voltage and the three-phase current that are transformed into the d-axis and q-axis forms through the Park transformation separately are input to a current control loop jointly. A current inner loop controller outputs a d-axis component and a q-axis component of the voltage to the inverter, and the d-axis component and the q-axis component are modulated through pulse-width modulation (PWM) in the process. The inverter outputs a regulated voltage and a regulated current, which are taken as a start voltage and a start current of the wind turbine generator set respectively, and a start voltage and a start current of the distributed energy storage system respectively.

It should be noted that for the voltage and the current in the present disclosure, the star in the upper right corner indicates that the voltage and the current are reference values, and the others indicate actual values.

The power controller calculates power according to the instantaneous power theory. In the droop control stage, the voltage and the frequency that are suitable for the distributed unit are acquired through droop power characteristics.

For the second control, first, corresponding communication connection is established between the distributed energy storage systems or new energy units, so that communication connection is established between adjacent distributed units. Then, the voltages and the frequencies of all the distributed units tend to reach global reference values according to a distribution consistency algorithm.

It should be noted that in a primary control process, the secondary control continuously acquires the global reference values of the voltages and the frequencies of all the distributed units according to the distribution consistency algorithm.

In some embodiments of the present disclosure, the power controller of the distributed unit calculates values of the active power and the reactive power that each encompass a direct-current component and an alternating-current component according to the instantaneous power theory; filters away the alternating-current components through a low-pass filter; and acquires a voltage and a frequency after a power change based on active power and reactive power generated after the alternating-current components are filtered away according to droop power characteristics. The active power and the reactive power are set as:

$$\{ \begin{matrix}{P}_{i} = \frac{{w}_{c}}{s + {w}_{c}} ( {u}_{odi} {i}_{odi} + {u}_{oqi} {i}_{oqi} ) \\ {Q}_{i} = \frac{{w}_{c}}{s + {w}_{c}} ( {u}_{oqi} {i}_{odi} - {u}_{odi} {i}_{oqi} )\end{matrix} \qquad ( 1 )$$

in the formula, w_{c} denotes a cutoff frequency, s denotes a Laplace variable, u_{odi} and u_{oqi} denote a d-axis component and a q-axis component of a load-side voltage of an i-th distributed unit respectively, i_{odi} and i_{oqi} denote a d-axis component and a q-axis component of a load-side current of the i-th distributed unit respectively, and Pᵢ and Qᵢ denote active power and reactive power of the i-th distributed unit respectively.

In some embodiments of the present disclosure, for Pᵢ and Qᵢ denoting the active power and the reactive power the i-th distributed unit respectively, the alternating-current component in the power is filtered away through the low-pass filter, so as to obtain the active power Pᵢ and the reactive power Qᵢ generated after the alternating-current components are filtered away.

The low-pass filter is designed such that it has little attenuation on a signal in a low-frequency region (passband) and significant attenuation on a signal in a high-frequency region (stopband). The alternating-current component generally encompasses high-frequency components. Thus, when entering the low-pass filter, these components are attenuated or filtered away.

In some embodiments of the present disclosure, a specific process of outputting the d-axis component and the q-axis component of the voltage and the frequency, output in the droop control stage, of the distributed unit is as follows: a specific control method based on the active power P and the reactive power Qᵢ generated after the alternating-current components are filtered away in combination with the droop controller of the distributed unit is as follows:

$$\{ \begin{matrix}{u}_{odi}^{*} & = {u}_{ni} - {n}_{i} {P}_{i} \\ {u}_{oqi}^{*} & = 0 \\ {f}_{i}^{*} & = {f}_{ni} - {m}_{i} {Q}_{i}\end{matrix} \qquad ( 2 )$$

in the formula,

$${u}_{odi}^{*}$$

denotes a d-axis component of a voltage reference value, output in a droop control stage, of the i-th distributed unit,

$${u}_{o q i}^{*}$$

denotes a q-axis component of a voltage reference value, output in the droop control stage, of the i-th distributed unit,

$${f}_{i}^{*}$$

denotes a frequency of the i-th distributed unit, uₙᵢ and fₙᵢ denote a rated value of a voltage and a rated value of a frequency of the i-th distributed unit respectively, and mᵢ and nᵢ denote a droop coefficient of active power and a droop coefficient of reactive power of the i-th distributed unit respectively.

In some embodiments of the present disclosure, the distributed unit employs a voltage-current dual-loop control design.

An actual voltage of the voltage outer loop controller changes with a voltage value obtained in the droop control stage. The voltage outer loop controller implements the function through a proportional-integral (PI) controller. An output value of the voltage outer loop controller is as follows:

$$\{ \begin{matrix}{i}_{di}^{*} = {K}_{pu} ( {u}_{odi}^{*} - {u}_{odi} ) + {K}_{iu} \int ( {u}_{odi}^{*} - {u}_{odi} ) - ω {Cu}_{oqi} + {i}_{odi} \\ {i}_{qi}^{*} = {K}_{pu} ( {u}_{oqi}^{*} - {u}_{oqi} ) + {K}_{iu} \int ( {u}_{oqi}^{*} - {u}_{oqi} ) - ω {Cu}_{odi} + {i}_{oqi}\end{matrix} \qquad ( 3 )$$

in the formula,

$${i}_{di}^{*} and {i}_{qi}^{*}$$

denote a d-axis component and a q-axis component of a current reference value output by the voltage outer loop controller respectively, Kₚᵤ denotes a proportional gain item of a PI controller in a voltage outer loop, Kᵢᵤ denotes an integral gain item of the PI controller, C denotes a filter capacitance value, and ω denotes a rated angular frequency.

An actual current of the current inner loop controller changes with a current reference value output by the voltage outer loop controller. The current inner loop controller implements the function through the PI controller. An output value of the current inner loop controller is as follows:

$$\{ \begin{matrix}{u}_{di}^{*} = {K}_{pi} ( {i}_{di}^{*} - {i}_{di} ) + {K}_{ii} \int ( {i}_{di}^{*} - {i}_{di} ) - ω {Li}_{qi} + {u}_{odi} \\ {u}_{qi}^{*} = {K}_{pi} ( {i}_{qi}^{*} - {i}_{qi} ) + {K}_{ii} \int ( {i}_{qi}^{*} - {i}_{qi} ) - ω {Li}_{di} + {u}_{oqi}\end{matrix} \qquad ( 4 )$$

in the formula,

$${u}_{di}^{*} and {u}_{q i}^{*}$$

denote a d-axis component and a q-axis component of a voltage output by the current inner loop controller respectively, i_{di} and i_{qi} denote a d-axis component and a q-axis component of a current flowing through an inductor L respectively, Kₚᵢ denotes a proportional gain item of a PI controller in a current inner loop, Kᵢᵢ denotes an integral gain item of the PI controller, and L denotes a filter inductance value. In the formula, i_{di} and i_{qi} are obtained by performing Park transformation on the current of the inductor L.

In some embodiments of the present disclosure, in the secondary control, change rates of the voltage and the frequency are calculated according to a multi-agent distribution consistency algorithm.

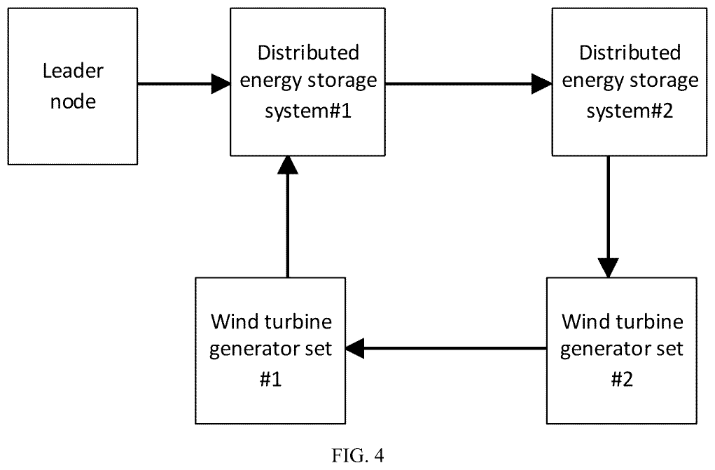

Each distributed energy storage system and the wind turbine generator set are taken as one agent to exchange information, i.e. a frequency and a voltage of each distributed power supply, and active power and reactive power output by each distributed power supply, with adjacent distributed units. A coordinated operation is performed according to state information between communication units, so as to cause state information in all the agents to tend to be consistent. One-way connected communication mode is employed, as shown in FIG. 4. The state information includes the frequency and the voltage of each distributed power supply, and the active power and the reactive power output by each distributed power supply.

Required consistency variables include the frequency and the voltage of each distributed power supply, and the active power and the reactive power output by each distributed power supply, which are recorded as

$${x}_{i} = \{ {ω}_{i}^{*} , {P}_{i} , {u}_{odi}^{*} , {Q}_{i} \} .$$

In the formula, xᵢ denotes a consistency variable of the i-th distributed unit, ωᵢ* denotes a reference frequency of the i-th distributed unit,

$${ω}_{i}^{*} = 2 π {f}_{i}^{*} , {u}_{odi}^{*}$$

denotes a reference voltage of the i-th distributed unit, and Pᵢ and Qᵢ denote active power and reactive power of the i-th distributed unit respectively.

A method for calculation based on a consistency variable of an adjacent distributed unit is as follows:

$${\dot{x}}_{i} = {\sum }_{j ∈ {n}_{i}} {a}_{ij} ( {x}_{j} ( t ) - {x}_{i} ( t ) ) + {g}_{i} ( {x}_{ref} ( t ) - {x}_{i} ( t ) ) \qquad ( 5 )$$

in the formula, \dot{x}ᵢ denotes a change rate of the consistency variable of the i-th distributed unit, aᵢⱼ denotes a weight coefficient of the information from j to i, gᵢ denotes a weight coefficient between the i-th distributed unit and a leader node, nᵢ denotes a set of all distributed units adjacent to the i-th distributed unit, and x_{ref} denotes a state parameter of the leader node.

Specifically,

$${w}_{i}^{*}$$

and Pᵢ encompassed in the consistency variables are applied to the distribution consistency algorithm, so as to adjust the frequency as follows:

$${\dot{ω}}_{i}^{*} = {\sum }_{j ∈ {n}_{i}} {a}_{ij} ( {ω}_{j}^{*} - {ω}_{i}^{*} ) + {g}_{i} ( {ω}_{ref} - {ω}_{i}^{*} ) + {\sum }_{j ∈ {n}_{i}} {a}_{ij} ( {m}_{j} {P}_{j} - {m}_{i} {P}_{i} ) \qquad ( 6 )$$

in the formula, \dot{ω}ᵢ* denotes a change rate of the frequency of the i-th distributed unit, ωᵢ* denotes the frequency of the i-th distributed unit, and ω_{ref} denotes a frequency of a virtual leader node.

Specifically,

$${u}_{odi}^{*}$$

and Qᵢ encompassed in the consistency variables are applied to the distribution consistency algorithm, so as to adjust the voltage as follows:

$${\dot{u}}_{odi}^{*} = {\sum }_{j ∈ {n}_{i}} {a}_{ij} ( {u}_{odj}^{*} - {u}_{odi}^{*} ) + {g}_{i} ( {u}_{ref} - {u}_{odi}^{*} ) + {\sum }_{j ∈ {n}_{i}} {a}_{ij} ( {n}_{j} {Q}_{j} - {n}_{i} {Q}_{i} ) \qquad ( 7 )$$

in the formula

$${\dot{u}}_{odi}^{*}$$

denotes a change rate of the voltage of the i-th distributed unit, and u_{ref} denotes a voltage value of the virtual leader node.

Then, the change rate of the voltage and the change rate of the frequency are fed back to the droop controller for correcting the voltage and the frequency, which may be expressed as follows:

$${f}_{i}^{c} = {f}_{ni} - {m}_{i} {Q}_{i} + \frac{{\dot{ω}}_{i}^{*}}{2 π} = {f}_{i}^{*} + \frac{{\dot{ω}}_{i}^{*}}{2 π} \qquad ( 8 )$$

$${u}_{odi}^{c} = {u}_{ni} - {n}_{i} {P}_{i} + {\dot{u}}_{odi}^{*} = {u}_{odi}^{*} + {\dot{u}}_{odi}^{*} \qquad ( 9 )$$

in the formula, mᵢ and nᵢ denote a droop coefficient of the active power and a droop coefficient of the reactive power of the i-th distributed unit respectively; and

$${f}_{i}^{c}$$

denotes a frequency value of the i-th distributed unit after correction through the secondary control, and

$${u}_{odi}^{c}$$

denotes a voltage value of the i-th distributed unit after correction through the secondary control.

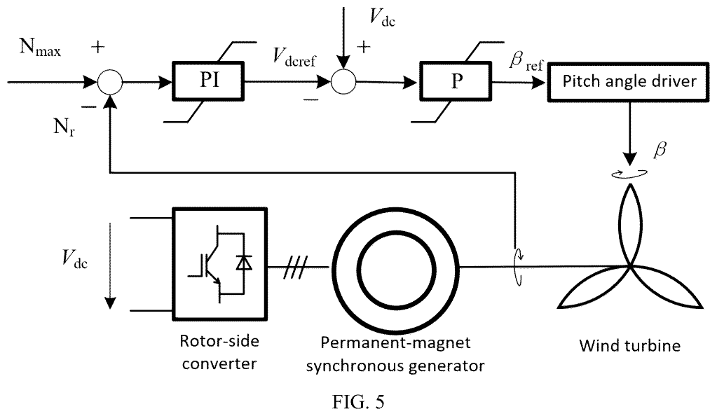

In some embodiments of the present disclosure, wind energy power captured by the wind turbine is decreased or increased by adjusting a blade pitch angle, so as to match load power. The present disclosure designs a dual-loop control structure including a speed control loop and a direct-current voltage control loop, as shown in FIG. 5. In the figure, Nₘₐₓ denotes a rotation speed given signal indicating a maximum rotation speed, Nᵣ denotes a rotation speed (r/min) of the wind turbine or a direct-drive motor, β_{ref} denotes a pitch angle instruction signal, where the pitch angle β of the wind turbine is controlled to be increased or decreased through a pitch angle driver, so that the rotation speed Nᵣ follows the given signal Nₘₐₓ, and V_{dc} denotes the direct-current voltage.

The speed control loop can ensure that a maximum rotation speed of the wind turbine is not exceeded. However, in the black start process, for different recovery loads, by relying on the speed control loop only, an increase in the direct-current voltage may be caused due to power imbalance. Thus, according to the present disclosure, one direct-current voltage inner loop is added on the basis of the speed control loop, so as to solve direct-current voltage pumping. To be specific, a difference between Nᵣ and Nₘₐₓ is processed by the PI regulator, so as to generate the direct-current voltage given value V_{dcref}. A difference between V_{dc} and V_{dcref} is calculated and processed by the PI regulator, so as to obtain β_{ref}. An upper-limit saturation value of the PI regulator for a rotation speed loop may be set to 1500 as a given value of the voltage inner loop. Thus, it is ensured that before the rotation speed Nᵣ reaches an instruction value Nₘₐₓ, the voltage inner loop follows the instruction value V_{dcref}. A proportional regulator is used in the voltage inner loop to ensure a regulation speed. The balance between the output of the wind turbine generator set and the load demand is achieved by controlling the pitch angle of the wind turbine. Thus, it is ensured that the direct-current voltage of the system is constant.

The present disclosure is further analyzed below with reference to a specific example.

### Example

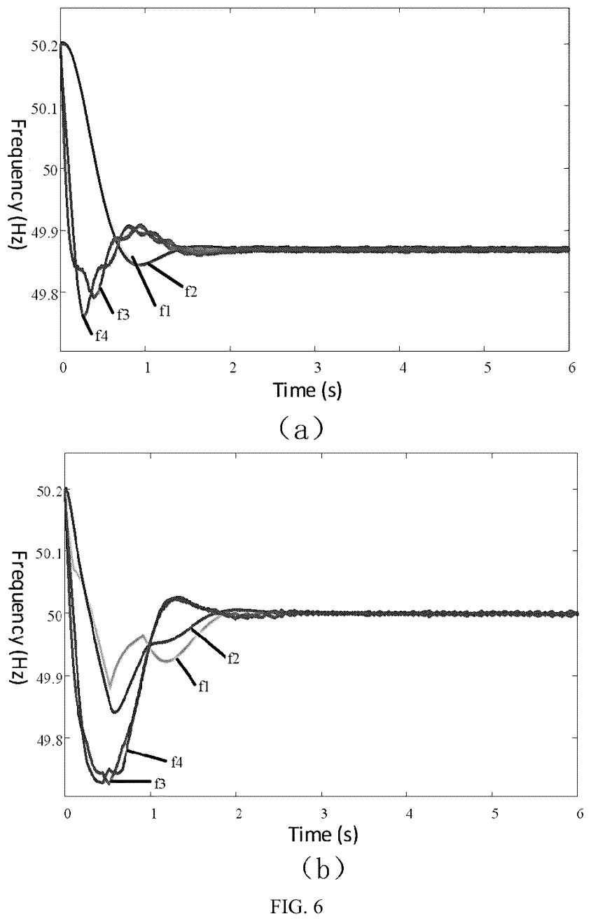

The control method of the present disclosure is applied to a system including two distributed energy storage units and two wind turbine generator sets, and droop coefficients in Table 1 are used. In a black start process, when the load is applied, frequencies of the system generated under primary control only and primary control and secondary control respectively are shown in FIG. 6.

TABLE 1
Droop Coefficients Of Distributed Energy Storage
System And Wind Turbine Generator Set

| | Distributed | Distributed | Wind | Wind |
|---|---|---|---|---|
| | energy | energy | turbine | turbine |
| | storage | storage | generator | generator |
| Parameter | system 1 | system 2 | set 1 | set 2 |
| m | 1.25 × 10⁻⁴ | 1.25 × 10⁻⁴ | 1.25 × 10⁻⁴ | 1.25 × 10⁻⁴ |
| n | 1.3 × 10⁻³ | 1.3 × 10⁻³ | 1.5 × 10⁻³ | 1.5 × 10⁻³ |

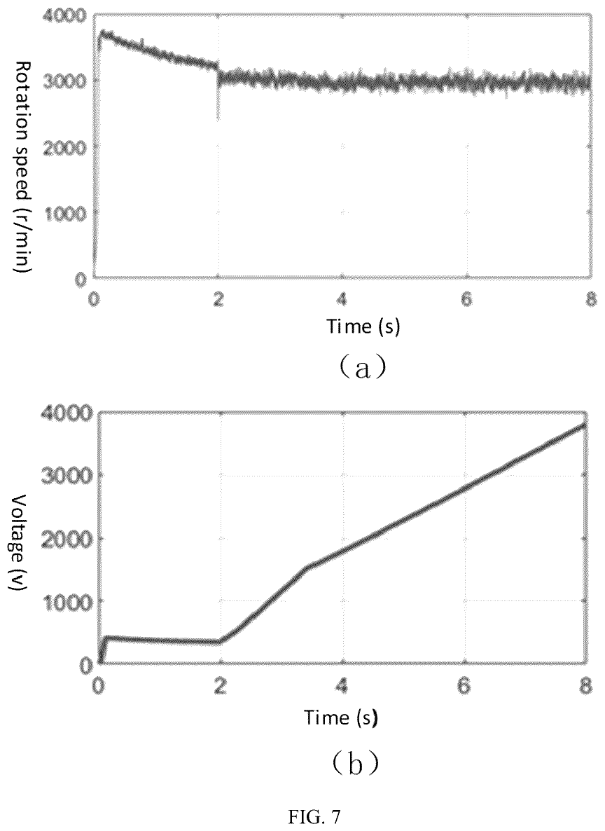

When power emitted by the wind turbine generator set during tracking according to maximum power is greater than the load, and no direct-current voltage loop is involved in pitch angle control, a rotation speed and a direct-current side voltage of the wind turbine generator set are shown in FIG. 7. A rotation speed given value is 3000 r/min, and a direct-current voltage given value between back-to-back converters is 1500 V. The rotation speed loop can control the rotation speed of the wind turbine generator set at a rated value, but the risk of breakdown is caused after excess energy is constantly accumulated on a direct-current capacitor. With the method of adding the voltage inner loop to the rotation speed loop provided by the present disclosure, the resulting rotation speed and direct-current side voltage of the wind turbine generator set are shown in FIG. 8. It can be seen that through the dual closed-loop control over the rotation speed and the voltage, the rotation speed of the wind turbine generator set is controlled at the rated value, and the direct-current voltage is stabilized at 1500 V. Moreover, it can be seen that the rotation speed of the wind turbine is gradually decreased to 405 r/min or so after 2 seconds. It indicates that in a case of a great wind speed, with an increase in the blade pitch angle, the rotation speed of the wind turbine is also decreased. Thus, input power of the wind turbine generator set matches the load demand.

What is described above is merely a preferred example of the present disclosure, but is not intended to limit the present disclosure. Any modifications, equivalent replacements, improvements, etc. made within the spirit and principles of the present disclosure should fall within the scope of protection of the present disclosure.

What is claimed is:

1. A black start control method for a distributed energy storage system and a permanent-magnet direct-drive type wind turbine generator set, comprising:
S1, reducing power of the wind turbine generator set by adjusting a pitch angle, and outputting, by an inverter, a voltage and a current after power reduction;
S2, transforming an actually-sampled value of the voltage and an actually-sampled value of the current into a voltage in d-axis and q-axis forms and a current in d-axis and q-axis forms respectively;
S3, acquiring, by a power controller, active power and reactive power of the distributed energy storage system or the wind turbine generator set based on the voltage transformed into the d-axis and q-axis forms and the current transformed into the d-axis and q-axis forms;
S4, acquiring, by a droop controller, a d-axis component and a q-axis component of a voltage reference value and a frequency based on the active power and the reactive power of the distributed energy storage system or the wind turbine generator set, wherein the d-axis component and the q-axis component of the voltage reference value and the frequency are corrected through a reference value output by secondary control, so as to obtain a corrected d-axis component, a corrected q-axis component, and a corrected frequency, and the reference value is acquired by the secondary control through a distribution consistency method;
S5, acquiring, by a voltage outer loop controller, a d-axis component and a q-axis component of a current reference value based on the corrected d-axis component, the corrected q-axis component, and the corrected frequency, and outputting a d-axis component and a q-axis component of the current in combination with the voltage transformed into the d-axis and q-axis forms and the current transformed into the d-axis and q-axis forms that are acquired in S2;
S6, acquiring, by a current inner loop controller, a d-axis component and a q-axis component of the voltage based on the d-axis component and the q-axis component of the current in combination with the voltage and the current that are transformed in form and acquired in S2; and
S7, controlling, by the inverter, the corresponding distributed energy storage system or wind turbine generator set based on the d-axis component and the q-axis component of the voltage.

2. The black start control method for a distributed energy storage system and a permanent-magnet direct-drive type wind turbine generator set according to claim 1, wherein in S1, a process of adjusting the pitch angle comprises: generating a direct-current voltage given value after a difference between a rotation speed of a wind turbine or a direct-drive motor and a rotation speed given signal is regulated by a proportional-integral (PI) regulator, calculating a difference between the direct-current voltage given value and a direct-current voltage actual value, regulating the difference through the PI regulator, and obtaining the pitch angle.

3. The black start control method for a distributed energy storage system and a permanent-magnet direct-drive type wind turbine generator set according to claim 1, wherein in S2, the voltage and the current are transformed into the d-axis and q-axis forms through Park transformation separately.

4. The black start control method for a distributed energy storage system and a permanent-magnet direct-drive type wind turbine generator set according to claim 1, wherein in S3, the power controller is expressed as follows:
$$\{ \begin{matrix}{P}_{i} = \frac{{w}_{c}}{s + {w}_{c}} ( {u}_{odi} {i}_{odi} + {u}_{oqi} {i}_{oqi} ) \\ {Q}_{i} = \frac{{w}_{c}}{s + {w}_{c}} ( {u}_{oqi} {i}_{odi} - {u}_{odi} {i}_{oqi} )\end{matrix} \qquad ( 1 )$$
in the formula, w_{c} denotes a cutoff frequency, s denotes a Laplace variable, u_{odi} and u_{oqi} denote a d-axis component and a q-axis component of a load-side voltage of an i-th distributed unit respectively, i_{odi} and i_{oqi} denote a d-axis component and a q-axis component of a load-side current of the i-th distributed unit respectively, and Pᵢ and Qᵢ denote active power and reactive power of the i-th distributed unit respectively.

5. The black start control method for a distributed energy storage system and a permanent-magnet direct-drive type wind turbine generator set according to claim 1, wherein in S4, the droop controller is expressed as follows:
$$\{ \begin{matrix}{u}_{odi}^{*} & = {u}_{ni} - {n}_{i} {P}_{i} \\ {u}_{oqi}^{*} & = 0 \\ {f}_{i}^{*} & = {f}_{ni} - {m}_{i} {Q}_{i}\end{matrix} \qquad ( 2 )$$
in the formula,
$${u}_{o d i}^{*}$$
denotes a d-axis component of a voltage reference value, output in a droop control stage, of an i-th distributed unit,
$${u}_{o q i}^{*}$$
denotes a q-axis component of the voltage reference value, output in the droop control stage, of the i-th distributed unit,
$${f}_{i}^{*}$$
denotes a frequency of the i-th distributed unit, uₙᵢ and fₙᵢ denote a rated value of a voltage and a rated value of a frequency of the i-th distributed unit respectively, mᵢ and nᵢ denote a droop coefficient of active power and a droop coefficient of reactive power of the i-th distributed unit respectively, Pᵢ and Qᵢ denote the active power and the reactive power of the i-th distributed unit respectively.

6. The black start control method for a distributed energy storage system and a permanent-magnet direct-drive type wind turbine generator set according to claim 5, wherein in S4, a specific formula for correcting the d-axis component and the q-axis component of the voltage reference value and the frequency through an amount output by the secondary control is as follows:
$${f}_{i}^{c} = {f}_{n i} - {m}_{i} {Q}_{i} + \frac{{\dot{ω}}_{i}^{*}}{2 π} = {f}_{i}^{*} + \frac{{\dot{ω}}_{i}^{*}}{2 π} \qquad ( 8 )$$
$${u}_{o d i}^{c} = {u}_{n i} - {n}_{i} {P}_{i} + {\dot{u}}_{o d i}^{*} = {u}_{o d i}^{*} + {\dot{u}}_{o d i}^{*} \qquad ( 9 )$$
in the formula,
$${f}_{i}^{c}$$
denotes a frequency value of the i-th distributed unit after correction through the secondary control,
$${u}_{o d i}^{c}$$
denotes a voltage value of the i-th distributed unit after correction through the secondary control,
$${\dot{ω}}_{i}^{*}$$
denotes a change rate of a reference frequency of the i-th distributed unit, and
$${\dot{u}}_{o d i}^{*}$$
denotes a change rate of a reference voltage of the i-th distributed unit.

7. The black start control method for a distributed energy storage system and a permanent-magnet direct-drive type wind turbine generator set according to claim 1, wherein in S4, the distribution consistency method comprises: exchanging consistency variable information of each distributed energy storage system or the wind turbine generator set; and causing a consistency variable of each distributed energy storage system or the wind turbine generator set to tend to be consistent through a consistency operation; wherein the consistency variable comprises the frequency, the voltage, the active power, and the reactive power; and a specific process of the consistency operation is as follows:
$${\dot{x}}_{i} = {\sum }_{j ∈ {n}_{i}} {a}_{i j} ( {x}_{j} ( t ) - {x}_{i} ( t ) ) + {g}_{i} ( {x}_{r e f} ( t ) - {x}_{i} ( t ) ) \qquad ( 5 )$$
in the formula, \dot{x}ᵢ denotes a change rate of a consistency variable of an i-th distributed unit, aᵢⱼ denotes a weight coefficient of the information from j to i, gᵢ denotes a weight coefficient between the i-th distributed unit and a leader node, nᵢ denotes a set of all distributed units adjacent to the i-th distributed unit, x_{ref}(t) denotes a state parameter of the leader node, xᵢ(t) denotes the i-th distributed unit, and xⱼ (t) denotes a j-th distributed unit.

8. The black start control method for a distributed energy storage system and a permanent-magnet direct-drive type wind turbine generator set according to claim 1, wherein in S5, the voltage outer loop controller is expressed as follows:
$$\{ \begin{matrix}{i}_{d i}^{*} = {K}_{p u} ( {u}_{o d i}^{*} - {u}_{o d i} ) + {K}_{i u} \int ( {u}_{o d i}^{*} - {u}_{o d i} ) - ω C {u}_{o q i} + {i}_{o d i} \\ {i}_{q i}^{*} = {K}_{p u} ( {u}_{o q i}^{*} - {u}_{o q i} ) + {K}_{i u} \int ( {u}_{o q i}^{*} - {u}_{o q i} ) - ω C {u}_{o d i} + {i}_{o q i}\end{matrix} \qquad ( 3 )$$
in the formula,
$${i}_{d i}^{*} and {i}_{q i}^{*}$$
denote the d-axis component and the q-axis component of the current reference value output by the voltage outer loop controller respectively, Kₚᵤ denotes a proportional gain item of a PI controller in a voltage outer loop, Kᵢᵤ denotes an integral gain item of the PI controller, C denotes a filter capacitance value, and w denotes a rated angular frequency.

9. The black start control method for a distributed energy storage system and a permanent-magnet direct-drive type wind turbine generator set according to claim 1, wherein in S6, the current inner loop controller is expressed as follows:
$$\{ \begin{matrix}{u}_{d i}^{*} = {K}_{p i} ( {i}_{d i}^{*} - {i}_{d i} ) + {K}_{i i} \int ( {i}_{d i}^{*} - {i}_{d i} ) - ω L {i}_{q i} + {u}_{o d i} \\ {u}_{q i}^{*} = {K}_{p i} ( {i}_{q i}^{*} - {i}_{q i} ) + {K}_{i i} \int ( {i}_{q i}^{*} - {i}_{q i} ) - ω L {i}_{d i} + {u}_{o q i}\end{matrix} \qquad ( 4 )$$
in the formula,
$${u}_{d i}^{*} and {u}_{q i}^{*}$$
denote the d-axis component and the q-axis component of the voltage reference value output by the current inner loop controller respectively, i_{di} and i_{qi} denote a d-axis component and a q-axis component of a current flowing through an inductor L respectively, Kₚᵢ denotes a proportional gain item of a PI controller in a current inner loop, Kᵢᵢ denotes an integral gain item of the PI controller, and L denotes a filter inductance value.

10. A black start control system for a distributed energy storage system and a permanent-magnet direct-drive type wind turbine generator set, comprising:
a power reduction module configured to reduce power of the wind turbine generator set by adjusting a pitch angle, and output, by an inverter, a voltage and a current after power reduction;
a transformation module configured to transform an actually-sampled value of the voltage and an actually-sampled value of the current into a voltage in d-axis and q-axis forms and a current in d-axis and q-axis forms respectively;
a power control module configured to acquire, by a power controller, active power and reactive power of the distributed energy storage system or the wind turbine generator set based on the voltage transformed into the d-axis and q-axis forms and the current transformed into the d-axis and q-axis forms;
a droop control module configured to acquire, by a droop controller, a d-axis component and a q-axis component of a voltage reference value and a frequency based on the active power and the reactive power of the distributed energy storage system or the wind turbine generator set, wherein the d-axis component and the q-axis component of the voltage reference value and the frequency are corrected through a reference value output by secondary control, so as to obtain a corrected d-axis component, a corrected q-axis component, and a corrected frequency, and the reference value is acquired by the secondary control through a distribution consistency method;
a voltage control module configured to acquire, by a voltage outer loop controller, a d-axis component and a q-axis component of a current reference value based on the corrected d-axis component, the corrected q-axis component, and the corrected frequency, and output a d-axis component and a q-axis component of the current in combination with the voltage transformed into the d-axis and q-axis forms and the current transformed into the d-axis and q-axis forms that are acquired through the transformation module;
a current control module configured to acquire, by a current inner loop controller, a d-axis component and a q-axis component of the voltage based on the d-axis component and the q-axis component of the current in combination with the voltage and the current that are transformed in form and acquired in S2; and
an inverter module configured to control, by the inverter, the corresponding distributed energy storage system or wind turbine generator set based on the d-axis component and the q-axis component of the voltage.
